(19) United States
(12) Patent Application Publication
(10) Pub. No.: US 2016/0066562 A1
(43) Pub. Date: Mar. 10, 2016

(54) COLLAPSIBLE DECOY SUPPORT

(71) Applicant: Stephen Boudwin, Green Bay, WI (US)

(72) Inventor: Stephen Boudwin, Green Bay, WI (US)

(21) Appl. No.: 14/848,763

(22) Filed: Sep. 9, 2015

Related U.S. Application Data
(60) Provisional application No. 62/048,341, filed on Sep. 10, 2014.

(51) Int. Cl. A01M 31/06; F16M 13/00; E04H 12/22; A01M 99/00

(52) U.S. Cl. CPC A01M 31/06; A01M 99/00; F16M 13/00; E04H 12/2215; F16M 2200/00

(57) ABSTRACT

An apparatus is configured for use with a ground stake and a decoy body. The apparatus includes a bracket, a pivot element, an elongated member, and an elongated slot provided in the elongated member. The bracket has a first abutment surface. The pivot element is connected to the bracket. The elongated member is configured as a support for the decoy body; the elongated member includes a second abutment surface configured to face the first abutment surface. The slot is configured for acceptance of the pivot element and comprises a travel path. The pivot element is configured for slideable motion within the slot, along the travel path. A method of using a decoy apparatus includes sliding the pivot element within the slot and along the travel path and pivoting the elongated member about the pivot element to change an orientation of the elongated member relative to a ground stake.

### CROSS REFERENCE TO RELATED APPLICATION

This application claims the benefit of priority from U.S. Provisional Patent Application No. 62/048,341, filed on Sep. 10, 2014, for a “Collapsible Decoy Support.” Application No. 62/048,341 is hereby fully incorporated by reference.

### BACKGROUND

Birds in general are flocking creatures, which means that birds are attracted to other birds. Hunters have realized that bird decoys are particularly useful for attracting waterfowl. As waterfowl migrate, they stop to rest. When they see a flock of decoys, they are attracted to the vicinity of the decoys as a resting spot. Waterfowl hunters prepare hunting areas by laying out decoys in an arrangement commonly known as a “spread.” Strategic locations for decoys are areas in which the waterfowl are known to frequent or that provide cover, food, or water for the waterfowl. The spread may include any number of decoys. In some cases, many hundreds of decoys may be set in a spread.

Conventional hunting decoys are well known. One known structure for a decoy is disclosed in U.S. Pat. No. 7,028,429 to Druliner, which is hereby incorporated by reference. The decoy generally has a head and neck portion fixed to a spike or stake inserted into the ground. A flexible bag of wind sock construction is mounted on the neck. The bag is constructed so that when wind enters an opening and fills the bag, the bag has the appearance of the body of a water fowl with a flared out center portion, giving the appearance of folded wings and a tapered rearward portion, giving the appearance of the tail of the water fowl.

A drawback of conventional decoys is that while the ground stake is generally oriented vertically, a body support for a bag or other body construction is generally oriented horizontally. This structure can make a decoy cumbersome to handle, store and transport.

Collapsible or foldable decoys have been designed, such as those described in U.S. Pat. No. 529,463 to Roberts; U.S. Pat. No. 2,450,572 to Ballard; U.S. Pat. No. 2,535,445 to Miller; U.S. Pat. No. 2,545,800 to Viken; U.S. Pat. No. 2,639,534 to Stossel; U.S. Pat. No. 3,245,168 to Pool; and U.S. Patent Application Publication 2014/0082992 to Mettler, for example. However, such known decoys may exhibit disadvantages in terms of cost, complexity, weight, low durability, and difficulty of use.

### SUMMARY

In a first aspect, an apparatus is configured for use with a ground stake and a decoy body. The apparatus comprises a bracket, a pivot element, an elongated member, and an elongated slot provided in the elongated member. The bracket has a first abutment surface. The pivot element is connected to the bracket. The elongated member is configured as a support for the decoy body; the elongated member comprises a second abutment surface configured to face the first abutment surface. The slot is configured for acceptance of the pivot element and comprises a travel path. The pivot element is configured for slideable motion within the slot, along the travel path.

In another aspect, a method of using a decoy apparatus comprises sliding the pivot element within the slot and along the travel path and pivoting the elongated member about the pivot element to change an orientation of the elongated member relative to the ground stake.

In yet another aspect, an apparatus comprises a decoy body of hollow construction, a ground stake, a bracket, a pivot element, an elongated member, an elongated slot provided in the elongated member, and a sleeve. The bracket has a first abutment surface. The pivot element is connected to the bracket. The elongated member is configured as a support for the decoy body; the elongated member comprises a second abutment surface configured to face the first abutment surface. The slot is configured for acceptance of the pivot element and comprises a travel path. The pivot element is configured for slideable motion within the slot, along the travel path. The sleeve is connected to the bracket and has a bore therethrough configured for passage of the ground stake.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views.

FIG. 1 is a side elevation view of an exemplary collapsible decoy support used in a decoy assembly (other components of the assembly are shown in phantom lines).

FIG. 2 is a front prospective view of a portion of the decoy of FIG. 1.

FIG. 3 is a left side elevation view of an exemplary collaspsible decoy support used in the decoys of FIGS. 1 and 2.

FIG. 4 is a right side elevation view of the exemplary support of FIG. 3.

FIG. 5 is a close-up view of a portion of the support of FIG. 3, with the hinge in a first configuration.

FIG. 6 is a view similar to FIG. 5, but with the hinge in a second configuration.

FIG. 7 is a front elevation view of the decoy of FIGS. 1 and 2, with the collapsible decoy support in a collapsed configuration.

FIG. 8 is an elevation view similar to FIG. 7, with the decoy head and body removed, of the collapsible decoy support in a collapsed configuration.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art which fall within the scope and spirit of the principles of this disclosure.

The figures may not be drawn to scale. In particular, some features may be enlarged relative to other features for clarity. Moreover, where terms such as above, below, over, under, top, bottom, side, right, left, etc., are used, it is to be understood that they are used only for ease of understanding the description. It is contemplated that structures may be oriented otherwise.

### DETAILED DESCRIPTION

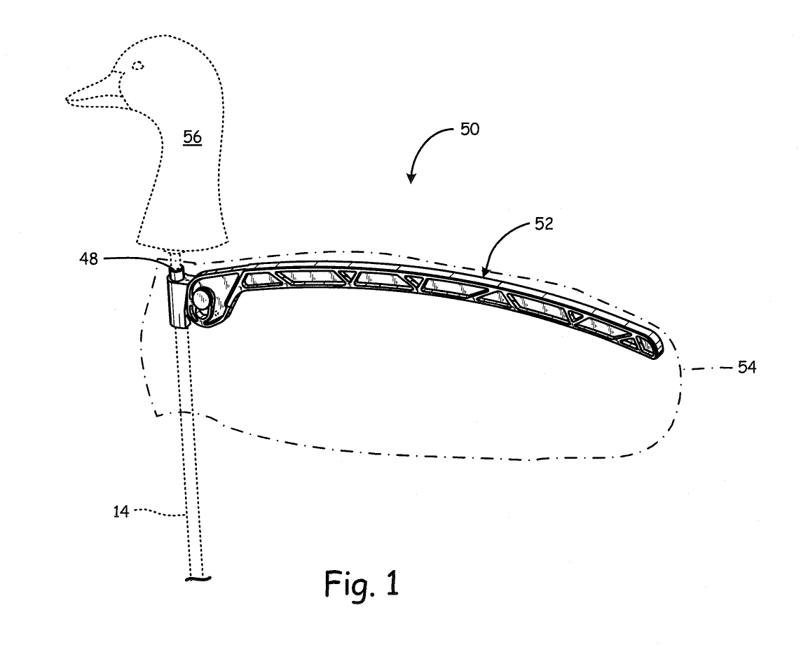

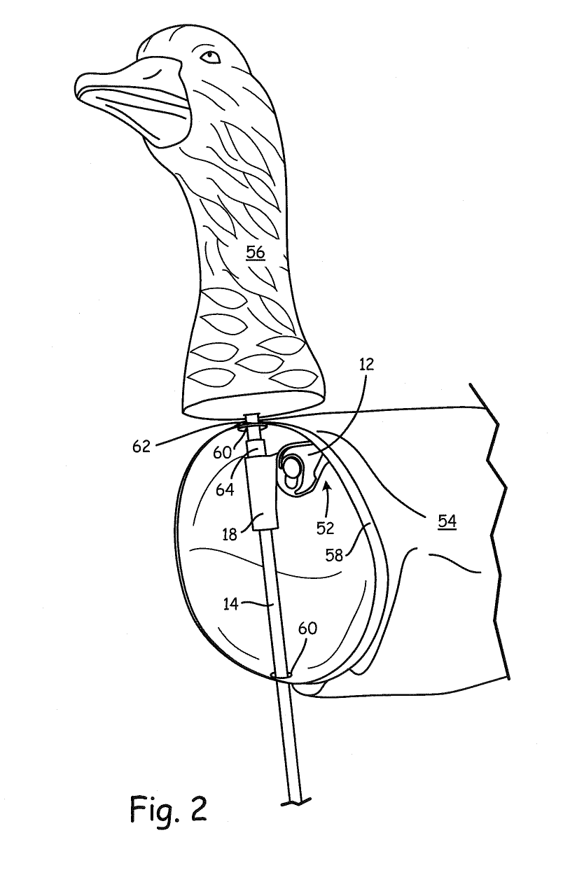

FIG. 1 is a side elevation view of a decoy 50 assembled using an exemplary collapsible decoy support 52 with an upright ground stake 14, decoy body 54 and decoy head 56. As shown in FIG. 2, in an exemplary embodiment, decoy body 54 of hollow construction is formed as a wind sock-type bag attached to hoop 58. Such a body 54 is further described in U.S. Pat. No. 7,028,429 to Druliner, which is hereby incorporated by reference. In the illustrated embodiment, decoy body 54 includes apertures 60 in hoop 58 for the passage of upright stake 14. In the illustrated embodiment, decoy head 56 is placed on a top end of upright stake 14. However, the decoy can also be used without a head 56, whereby a cap (not shown) can be placed at the top end 62 of upright stake 64 to prevent detachment of decoy body 54 from upright stake 14. Spacer 64 may be placed between collapsible decoy support 52 and a top portion of hoop 58 of decoy body 54 to provide a clearance between the support arm 12 and the top of decoy body 54 and/or head 56. Spacer 64 may be integrally formed with sleeve 18 or may be provided as a separate component.

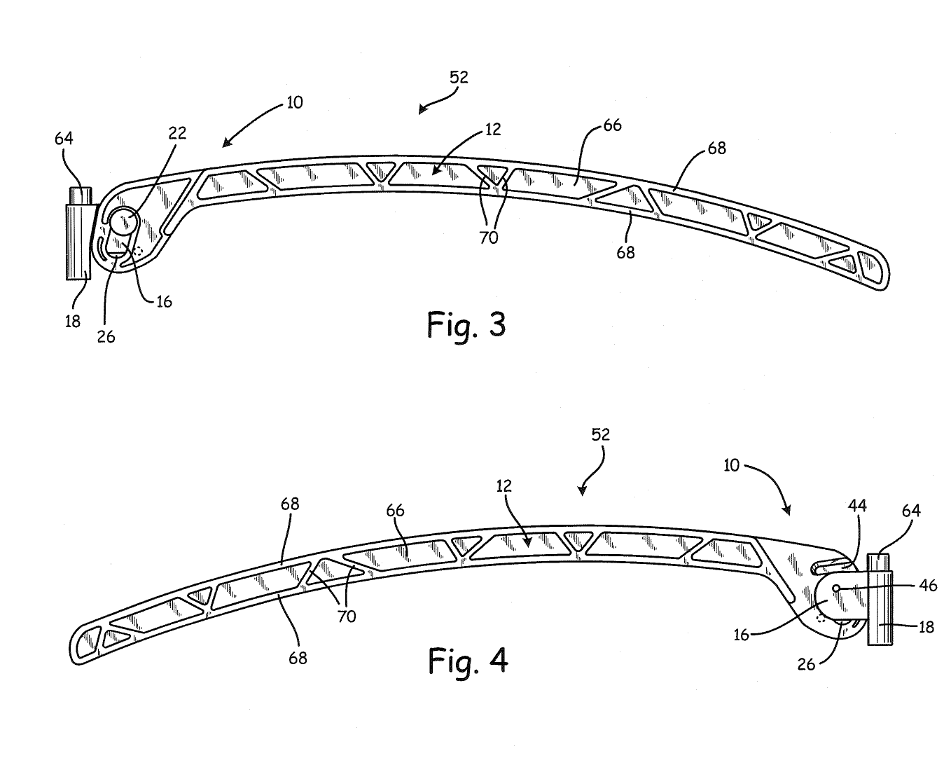

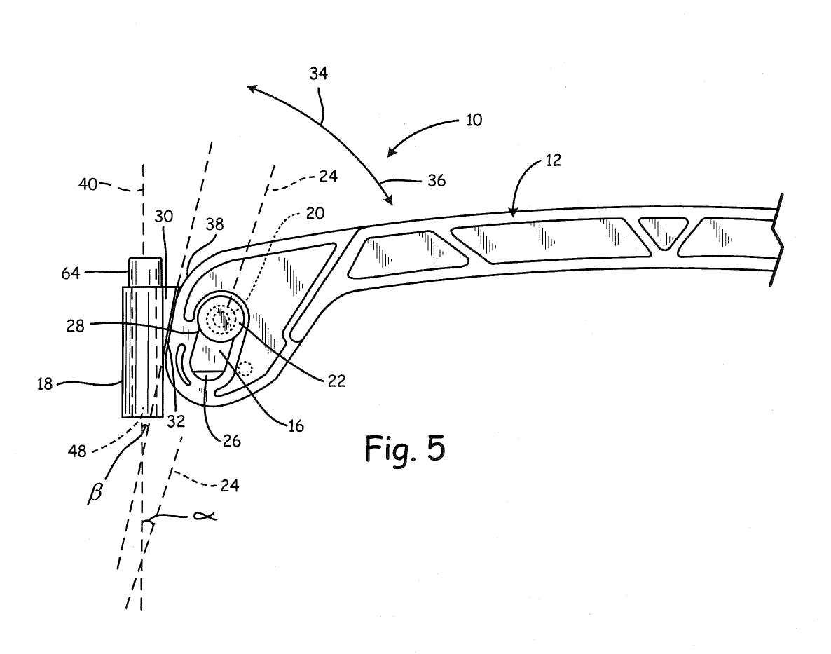

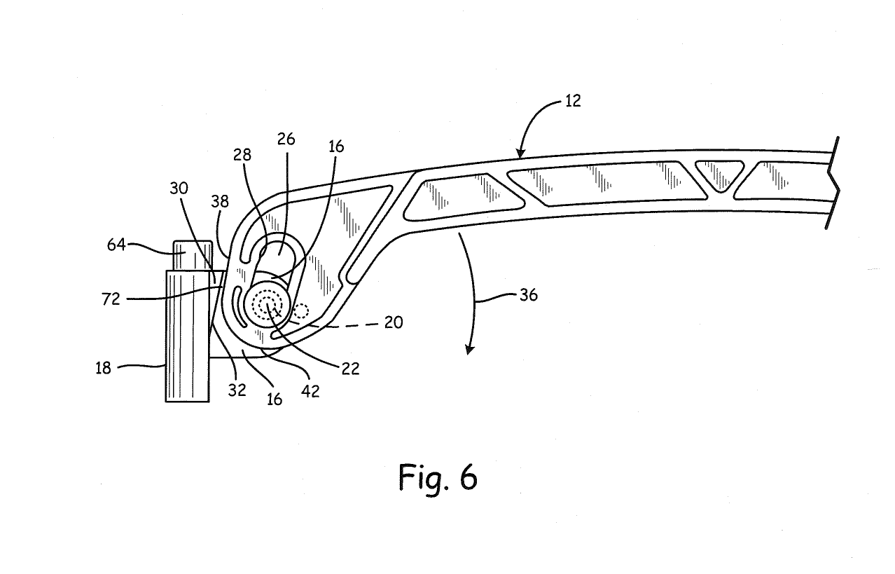

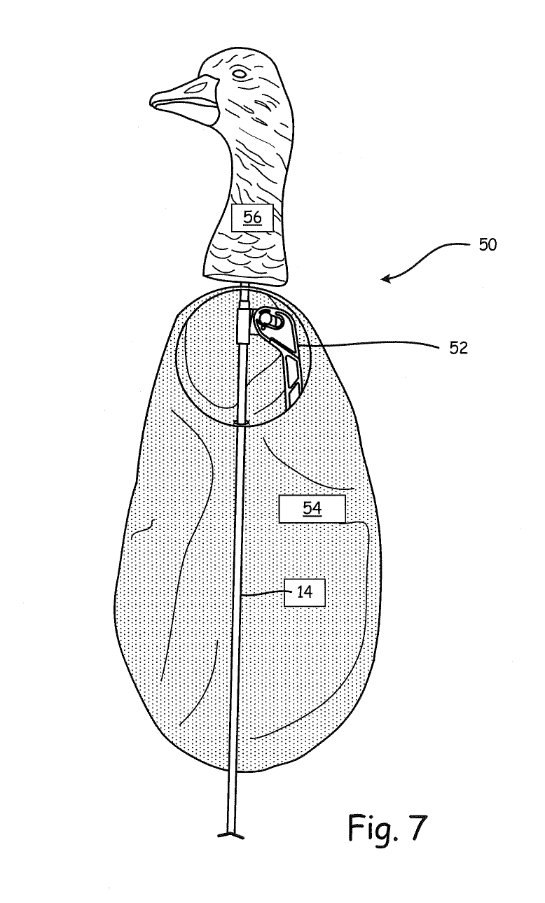

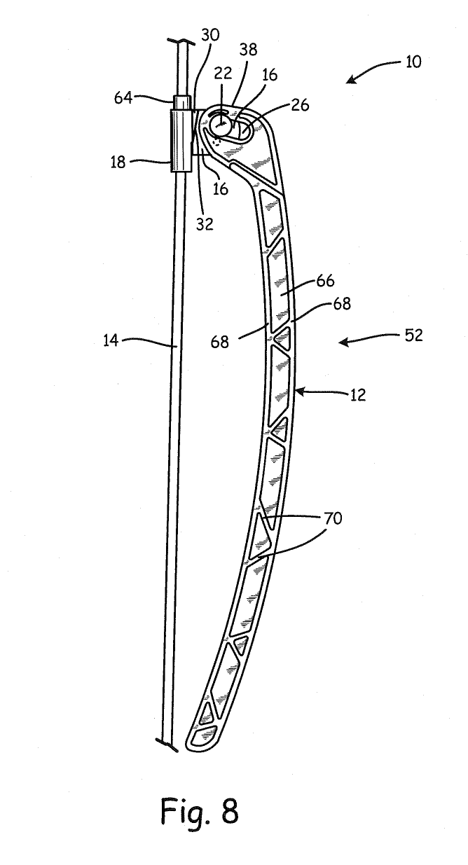

FIGS. 3 and 4 show left and right side elevation views, respectively, of an exemplary collapsible decoy support 52 of the present disclosure. A specially designed hinge 10 allows the support arm 12 of a decoy to pivot down so that it is substantially aligned with an upright stake 14 for compact storage and handling (as shown in FIGS. 7 and 8, for example). Hinge 10 includes a bracket 16 attached to a vertical cylindrical sleeve 18, which has a bore 48 therethrough (labeled in FIGS. 1 and 5) for insertion of upright stake 14. In an exemplary embodiment, stake 14 is frictionally received within bore 48 to maintain relative positions of stake 14 and sleeve 18 as desired. Bracket 16 includes screw collar 20 connected thereto (shown in phantom in FIGS. 5 and 6) for acceptance of an inserted screw 22. In an exemplary embodiment, screw collar is an internally threaded cylinder formed on bracket 16, which accepts the threaded shaft of screw 22. Screw collar 20 is positioned within slot 26 and is slideable along a travel path of elongated slot 26 of support arm 12. In the illustrated embodiment, slot 26 is linear and has a longitudinal axis 24 along which the travel path of screw 22 is aligned. However, it is contemplated that an elongated slot may have a curvilinear or other configuration.

Screw 22 has a head having a diameter greater than a width of slot 26 (the width being perpendicular to longitudinal axis 24). Accordingly, screw 22 attaches support arm 12 to bracket 16. Support arm 12 is an elongated member configured as a support for decoy body 54.

In an exemplary embodiment, support arm 12 has generally an I-beam construction with a web 66 bound by flanges 68; the support arm 12 also includes a plurality of stiffening ribs 70. It is contemplated that stiffening ribs 70 may have shapes, sizes, numbers and placements different from those shown.

FIG. 4 additionally shows ledge 44, which a top surface of bracket 16 contacts when screw 22 is at the top of slot 26. Moreover, in some embodiments, bracket 16 includes screw end cover 46 to contain the end of screw 22. Screw end cover 46 may be formed integrally with bracket 16 or separately therefrom. In another embodiment, screw 22 may be short enough that its end does not extend past a thickness of bracket 16, and so now screw end cover 46 is present.

FIG. 5 is a close-up view of a portion of FIG. 3. In an exemplary embodiment, slot 26 includes a slight bump 28 (most easily seen in FIG. 6), which serves as a detent to hold the screw collar 20 at the top of the slot 26. Sleeve 18 is connected to bracket 16 and includes a longitudinal bore 48 through which upright stake 14 passes. Buttress 30 is provided on vertical cylindrical sleeve 18 in front of bracket 16 to provide a surface 32 facing surface 38 of support arm 12 and against which surface 38 of support arm 12 abuts, thereby preventing support arm 12 from pivoting about screw 22 in direction 34 or 36 in the first configuration of FIGS. 1-5.

In an exemplary embodiment, when collapsible decoy support 52 is in the first configuration shown in FIGS. 1-5, vertical axis 40 of bore 48 of sleeve 18 is not parallel to axis 24 of slot 26. Moreover, vertical axis 40 is not parallel to a straight portion of surface 38 of support arm 12. In an exemplary embodiment, vertical axis 40 intersects each of axis 24 and the straight portion of surface 38 at acute angles. Additionally, a distance (measured perpendicular to axis 24) between surface 38 and axis 24 at a top portion of slot 26 is greater than a distance between surface 38 and axis 24 at a bottom portion of slot 26. Accordingly, the angle α between slot axis 24 and vertical axis 40 of bore 48 is greater than the angle β between the straight portion of surface 38 and vertical axis 40. In an exemplary embodiment, in the first configuration shown in FIG. 5, surfaces 32 and 38 face each other and are in direct contact. Thus, the angle β also describes the angle between ramp surface 32 of buttress 30 and vertical axis 40. In an exemplary embodiment, the angle β between surface 32 and the vertical axis 40 of upright stake 14 is about 9 degrees, though other acute angles are also suitable.

FIG. 6 shows that with manual force, the support arm 12 can be pushed upward (relative to bracket 16 and sleeve 18) so that the screw collar 20 is pushed past the bump 28 to a position at the bottom of the slot 26. Thus, movement of support arm 12 upward along slot axis 24 results in a clearance gap 72 between surface 32 and surface 38, which then facilitates the pivoting movement of support arm 12 relative to buttress 30 in direction 36. In an exemplary embodiment, screw collar 20 serves as a pivot element and defines an axis about which support arm 12 pivots. The pivoting motion is also made possible because the distance between bottom surface 42 of support arm 12 and slot 26 is substantially equal to or less than the distance between surface 38 and a bottom portion of slot 26. Accordingly, the support arm 12 can be pivoted about the screw collar 20 in the direction 36. Thus, the support arm 12 can be pivoted in a range of about 90 degrees or greater, to change an orientation of support arm 12 relative to upright stake 14. For example, as shown in FIGS. 7 and 8, support arm 12 is shown folded down to substantially align with upright stake 14.

By providing elongated slot 26 at an acute angle α relative to vertical axis 40, as support arm 12 is pushed upward, it also moves to the right (as viewed in FIGS. 5 and 6). Moreover, movement of support arm 12 at an acute angle relative to vertical axis 40 makes it more intuitive for a user to then pivot support arm 12 in direction 36 to change the configuration of collapsible decoy support 52 because motion is limited in the opposite direction 34. FIG. 7 is a front elevation view of the decoy 50 of FIGS. 1 and 2, with support arm 12 of collapsible decoy support 52 pivoted down to an orientation substantially aligned with upright stake 14, for compact handling, storage and transport. FIG. 8 is an elevation view similar to FIG. 7, with the decoy head 56 and body 54 removed.

Although the subject of this disclosure has been described with reference to several embodiments, workers skilled in the art will recognize that changes may be made in form and detail without departing from the spirit and scope of the disclosure. For example, while the disclosure describes a decoy of water fowl such as goose or duck, it is contemplated that the disclosed collapsible support may be used for decoys of other animals as well. Moreover, the disclosed collapsible support may be used in other structures that are staked to the ground, such as lawn ornaments, for example. In addition, any feature disclosed with respect to one embodiment may be incorporated in another embodiment, and vice-versa.

What is claimed is:

1. An apparatus configured for use with a ground stake and a decoy body, the apparatus comprising:
a bracket having a first abutment surface;
a pivot element connected to the bracket;
an elongated member configured as a support for the decoy body, the elongated member comprising a second abutment surface configured to face the first abutment surface; and
an elongated slot provided in the elongated member, wherein the slot is configured for acceptance of the pivot element, wherein the slot comprises a travel path;
wherein the pivot element is configured for slideable motion within the slot, along the travel path.

2. The apparatus of claim 1 wherein the pivot element is a screw collar, the apparatus further comprising a screw configured for insertion into the screw collar, wherein the screw is also configured to attach the elongated member to the bracket.

3. The apparatus of claim 1 further comprising a sleeve connected to the bracket, the sleeve having a bore therethrough configured for passage of the ground stake.

4. The apparatus of claim 3 wherein the bore has a longitudinal axis, and wherein the longitudinal axis of the bore is not parallel to the travel path of the slot.

5. The apparatus of claim 3 wherein the bore has a longitudinal axis, and wherein the second abutment surface is not parallel to the longitudinal axis of the bore.

6. The apparatus of claim 3 wherein the bore has a longitudinal axis, and wherein:
the longitudinal axis of the bore intersects the second abutment surface at a first acute angle;
the longitudinal axis of the bore intersects the travel path of the slot at a second acute angle;
wherein the first acute angle is less than the second acute angle.

7. The apparatus of claim 1 wherein the slot comprises a detent configured to hold the pivot element in a position.

8. The apparatus of claim 1 wherein the slot comprises a top portion and a bottom portion;
wherein a first distance is defined between the second abutment surface and the longitudinal axis of the slot at the top portion of the slot, the first distance being measured perpendicular to the travel path of the slot;
wherein a second distance is defined between the second abutment surface and the longitudinal axis of the slot at the bottom portion of the slot, the second distance being measured perpendicular to the travel path of the slot; and
wherein the second distance is less than the first distance.

9. A method of using a decoy apparatus, the apparatus comprising:
a bracket having a first abutment surface;
a pivot element connected to the bracket;
an elongated member configured as a support for the decoy body, the elongated member comprising a second abutment surface configured to face the first abutment surface;
an elongated slot provided in the elongated member, wherein the slot is configured for acceptance of the pivot element, wherein the slot comprises a travel path; and
a sleeve connected to the bracket, the sleeve having a bore therethrough configured for passage of a ground stake;
the method comprising:
sliding the pivot element within the slot and along the travel path; and
pivoting the elongated member about the pivot element to change an orientation of the elongated member relative to the ground stake.

10. The method of claim 9 wherein sliding the pivot element within the slot comprises moving the pivot element past a detent.

11. The method of claim 9 wherein sliding the pivot element within the slot comprises creating a clearance gap between the first abutment surface and the second abutment surface.

12. The method of claim 9 wherein pivoting the elongated member about the pivot element comprises rotating the elongated member about the pivot member in a range of about 90 degrees.

13. An apparatus comprising:
a decoy body of hollow construction;
a ground stake;
a bracket having a first abutment surface;
a pivot element connected to the bracket;
an elongated member configured as a support for the decoy body, the elongated member comprising a second abutment surface configured to face the first abutment surface;
an elongated slot provided in the elongated member, wherein the slot is configured for acceptance of the pivot element, wherein the slot comprises a travel path;
wherein the pivot element is configured for slideable motion within the slot, along the travel path; and
a sleeve connected to the bracket, the sleeve having a bore therethrough configured for passage of the ground stake.

14. The apparatus of claim 13 wherein the pivot element is a screw collar, the apparatus further comprising a screw configured for insertion into the screw collar, wherein the screw is also configured to attach the elongated member to the bracket.

15. The apparatus of claim 13 wherein the bore has a longitudinal axis, and wherein the longitudinal axis of the bore is not parallel to the travel path of the slot.

16. The apparatus of claim 13 wherein the bore has a longitudinal axis, and wherein the second abutment surface is not parallel to the longitudinal axis of the bore.

17. The apparatus of claim 13 wherein the bore has a longitudinal axis, and wherein:
the longitudinal axis of the bore intersects the second abutment surface at a first acute angle;
the longitudinal axis of the bore intersects the longitudinal axis of the slot at a second acute angle;
wherein the first acute angle is less than the second acute angle.

18. The apparatus of claim 13 wherein the slot comprises a detent configured to hold the pivot element in a position.

19. The apparatus of claim 13 wherein the slot comprises a top portion and a bottom portion;
wherein a first distance is defined between the second abutment surface and the longitudinal axis of the slot at the top portion of the slot, the first distance being measured perpendicular to the travel path of the slot;
wherein a second distance is defined between the second abutment surface and the longitudinal axis of the slot at the bottom portion of the slot, the second distance being measured perpendicular to the travel path of the slot; and
wherein the second distance is less than the first distance.
